(19) United States
(12) Patent Application Publication
(10) Pub. No.: US 2023/0037949 A1
(43) Pub. Date: Feb. 9, 2023

(54) REMOVAL OF AMINES FROM AQUEOUS STREAMS

(71) Applicant: Metso Outotec Finland Oy, Tampere (FI)

(72) Inventors: Kaj Jansson, Tampere (FI); Eija Saari, Espoo (FI)

(73) Assignee: Metso Outotec Finland Oy, Tampere (FI)

(21) Appl. No.: 17/790,200

(22) PCT Filed: Dec. 31, 2019
(86) PCT No.: PCT/FI2019/050933

§ 371 Date: Jun. 30, 2022

(51) Int. Cl. B03D 1/02; B03D 1/08; B03D 1/14; C02F 1/463; C02F 9/00; C02F 11/12

(52) U.S. Cl. CPC B03D 1/02; B03D 1/082; B03D 1/1431; C02F 1/463; C02F 9/00; C02F 11/12; C02F 2101/10

(57) ABSTRACT

A method and an arrangement for removing amine(s) from a thickener overflow of a mineral processing plant. The method includes supplying the thickener overflow to an electrocoagulation unit and subjecting the thickener overflow to electrocoagulation in order to separate at least some of the amine(s) as an electrocoagulation overflow and in order to form a residual process water as an electrocoagulation underflow, and removing the electrocoagulation overflow. The method is free of all of the following: a coagulant, a flocculant, an adsorbent and an additional flotation chemical.

### TECHNICAL FIELD

This specification relates to a method and an arrangement for removing amine(s) from a thickener overflow of a mineral processing plant.

### BACKGROUND

Amines are a group of organic compounds widely used by the mineral processing industry. Their use especially as flotation agents is growing fast. There are, however, environmental problems related to the use of amines as flotation agents. Amines accumulate in large quantities in tailings dams wherein they present incomplete (bio)degradation. Consequently, mine tailings containing production chemicals such as amine-based collectors, pose a threat to aquatic organisms living in downstream ecosystems of the mineral processing units. Protective legislation concerning the use of amines is inevitably emerging. This will cause severe restrictions to the use of amines as flotation agents unless their removal from aqueous solutions can be improved. Consequently, there is a need to find a solution for removal of amine-based flotation chemicals from the process waters.

### SUMMARY

It is an aim of this specification is to provide a method and an arrangement for removing amine(s) from a thickener overflow of a mineral processing plant. Further aim is to provide a method and an arrangement for improving quality of the thickener overflow to such an extent that the thus formed residual process water may be led to the environment as such, or alternatively, the residual process water may be recycled back into the process for use as process water.

According to an embodiment, a method for removing amine(s) from a thickener overflow of a mineral processing plant is provided. The thickener overflow comprises process water and amine(s). The method comprises:
supplying the thickener overflow to an electrocoagulation unit and subjecting the thickener overflow to electrocoagulation in order to separate at least some of the amine(s) as an electrocoagulation overflow and in order to form a residual process water as an electrocoagulation underflow, and
removing the electrocoagulation overflow.

The method is free of all of the following: a coagulant, a flocculant, an adsorbent and an additional flotation chemical.

According to an embodiment, an arrangement for removing amine(s) from a thickener overflow of a mineral processing plant is provided. The thickener overflow comprises process water and amine(s). The arrangement comprises
a thickener arranged to dewater an overflow of a mineral flotation circuit in order to produce a thickener overflow and a thickener underflow,
an electrocoagulation unit arranged to separate at least some of the amine(s) from the thickener overflow as an electrocoagulation overflow and to form a residual process water as an electrocoagulation underflow.

### BRIEF DESCRIPTION OF THE DRAWINGS

FIG. 1 illustrates, by way of an example, a schematic process flow chart according to an embodiment,

FIG. 2 illustrates, by way of an example, a schematic process flow chart according to an embodiment,

FIG. 3 illustrates, by way of an example, a schematic process flow chart according to an embodiment,

FIG. 4 illustrates, by way of an example, a schematic process flow chart according to an embodiment

FIG. 5 illustrates, by way of an example, a schematic process flow chart according to an embodiment from the electrocoagulation unit onwards, and

FIG. 6 illustrates, by way of an example, a schematic process flow chart according to another embodiment from the electrocoagulation unit onwards.

The figures are schematic. The figures are not in any particular scale.

### DETAILED DESCRIPTION

The solution is described in the following in more detail with reference to some embodiments, which shall not be regarded as limiting.

In this description and claims, the term “comprising” may be used as an open term, but it also comprises the closed term “consisting of”.

In mining industry, beneficiation refers to a process that improves the economic value of the ore by removing gangue minerals, the process resulting in a higher grade product (concentrate) and a waste stream, i.e. tailings. Examples of beneficiation processes include e.g. froth flotation and gravity separation. Term “gangue” refers to commercially worthless material that surrounds, or is closely mixed with, a wanted mineral in an ore deposit.

Beneficiation by flotation of low-grade oxidised iron ores is called reverse flotation, wherein the gangue is separated by flotation from the valuable finely grained iron ores. The valuable ore is collected from the underflow of the flotation unit. The gangue is separated from the ore with the help of collector chemicals, which typically are surface active organic reagents. The most common flotation route used for the beneficiation of the low-grade iron ores is reverse cationic flotation. The advantages of reverse cationic flotation over anionic flotation include a higher process selectivity and rate, as well as satisfactory results when using hard water.

Typically, the gangue froth removed by the reverse flotation is sent to a tailings dam where the long resident time, typically 20-40 days, is expected to sediment and separate the solids, as well as decompose residual flotation chemicals from the collected and reusable process water. The collected process water is then recirculated back into the beneficiation process. The quality of the recirculated process water plays a role in obtaining target recoveries and qualities of the final product.

In reverse flotation of Fe, typically hydrophobic amine-based flotation chemicals (collectors) are used to attach to the gangue particles and increase their hydrophobicity so that they can be removed as overflow in the reverse flotation step. Amine-based collectors are used especially in the reverse flotation of iron ore as they allow selective separation of the gangue material, for example quartz/silicate particles, from the valuable iron oxides. The separation is based on the capability of the amine-based compounds to adsorb onto particle surface, thereby forming mineralized froth that can be removed. By the use of amine-based collectors silicate content of the ore may be reduced for example from a level of higher than 2% to a level of 0.6% silicate in the recovered ore. For removal of silicates during reverse cationic flotation, a collector based on a mixture of a primary ether amine and a non-ionic surfactant, such as a fatty alcohol, may be used. Conventionally, the removed mineralized froth is dumped into tailings dams, as described above.

Apart from being time-consuming, the conventional treatment method (dumping into tailings dams) has significant space requirements and is also subject to problems for example due to rain, breakage and maintenance. Changing over to other tailings methods such as thickened tailings, paste, dry stacking or hybrids of these, results in much shorter sedimentation time, of for example 3-8 h. However, when for example the hydrophobic amine-based collectors or other particles are sent to a tailings thickener, they tend to float or follow water flow more easily instead of sedimenting as desired, thereby ending up in the thickener overflow. Also, other light materials with low density such as organic material, bacteria and other microbes, colloidal and soluble material will follow the water flow to the thickener overflow.

Today, water shortage, ecological demands placed by legislation and public pressure, costs and extensive space requirements of the aforementioned conventional tailings methods for process water treatment increasingly put pressure to recirculate process waters as main processes in flotation become at least partially closed-loop systems in terms of water usage. The above described thickener overflow to be reused as a process water may comprise a significant amount of silicates which, when water is recirculated back into the flotation process, use up flotation chemicals and disrupt floating of silicates from the freshly introduced slurry infeed. Silicates may end up in the recovered Fe material in the underflow, which deteriorates both yield and quality of the Fe material. Also other residual chemicals and harmful or detrimental substances ending up in the thickener overflow, and later in the recycled process water may affect negatively the main flotation process and final product quality if not properly handled prior to recycling the process water back into the main process.

Conventional solution to control the accumulation of collector chemicals and suppress microbiological growth is to send the flotation froth to the tailings dam with a long retention time. However, as mentioned above, there are environmental problems relating to the use of in particularly amines as flotation agents. Mine tailings containing amine collectors pose a threat to aquatic organisms living in downstream ecosystems of the mineral processing units. In particularly, high levels of fatty amines cannot be directly disposed into aquatic bodies. Moreover, the harmfulness or toxicity of the amine degradation products to the environment is not complete known.

This specification aims to provide a method and an arrangement that enable removal of amine(s) from the thickener overflow as well as improving quality of the thickener overflow to such an extent that the thus formed residual process water may be led to the environment as such, or alternatively, the residual process water may be recycled back into the process.

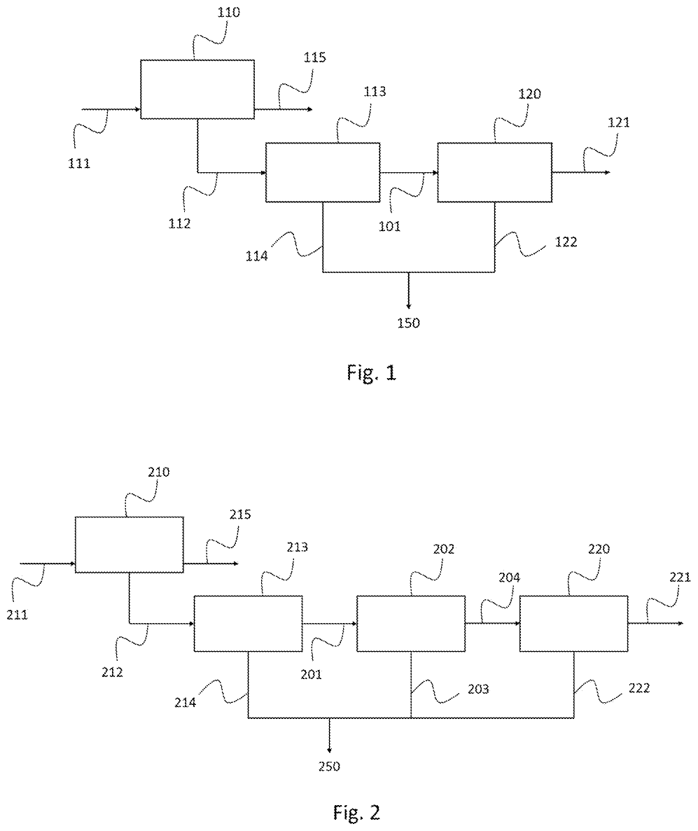

An exemplary flotation arrangement for reverse flotation of for example Fe in combination with a process water treatment arrangement for removing amine(s) is illustrated in FIG. 1.

Within context of this specification, amine(s) to be removed refer to the amine-based flotation chemical(s) (amine-based collector(s)) that instead of sedimenting in a thickener have ended up in the thickener overflow.

A mineral flotation circuit 110 is arranged to treat ore particles suspended in a slurry 111 by flotation. The mineral flotation circuit 110 is arranged to separate the slurry 111 into an underflow of the mineral flotation circuit 115 and an overflow of the mineral flotation circuit 112. Hence, the mineral flotation circuit 110 is arranged to operate by a reverse flotation. The underflow of the mineral flotation circuit 115 comprises recovered, for example Fe-containing, material.

The overflow of the mineral flotation circuit 112 is led into a thickener 113. In the thickener 113, the overflow of the mineral flotation circuit 112 is dewatered to produce a thickener overflow 101 and a thickener underflow 114. The thickener underflow 114 is removed from the thickener 113. The thickener underflow 114 is typically removed from the thickener as tailings 150. The thickener 113 is configured to operate as a solid-liquid separator to separate a sediment, i.e. the thickener underflow 114, from a supernatant, i.e. the thickener overflow 101. The thickener underflow 114 comprises particles having a density higher than the one of the liquid, and thus ending up in the sediment. The solids content of the thickener underflow 114 may be at least 80 wt. %.

The thickener overflow 101 comprises process water, amine(s), and Si-containing compounds and/or particles, typically silicates. The thickener overflow may further comprise other undesired, detrimental or unrecovered material or compounds such as fine particles and larger particles comprising C, P, N, Ca, K, Mn, Mg; starch-based depressants, microbes etc., suspended and/or dissolved in process water. Concentration of the amine(s) in the thickener overflow 101 may be 1-200 mg/I, preferably 30-100 mg/I, more preferably 50-60 mg/I. The thickener overflow 101 received from the thickener 113 is in a highly unstable state and more diverse in its composition, when compared for example to the state of the effluent water received from the tailings area.

In a method according to an embodiment and as illustrated in FIG. 1, the thickener overflow 101 is supplied to an electrocoagulation unit 120. In the electrocoagulation unit 120 the thickener overflow 101 is subjected to electrocoagulation in order to separate at least some of the amine(s) as an electrocoagulation overflow 122. An electrocoagulation underflow 121 thus formed comprises a residual process water. The electrocoagulation overflow 122 is removed. By electrocoagulation, at least some of the amines contained by the thickener overflow 101 may get removed as the electrocoagulation overflow 122. Additionally or alternatively, chemistry of at least some of the amines of the thickener overflow 101 may get changed. The electrocoagulation overflow 122 may be removed as tailings 150. The method is free of all of the following: a coagulant, a flocculant, an adsorbent and an additional flotation chemical. The additional flotation chemical refers to a flotation chemical other than the amine(s) already comprised by the thickener overflow. With the method, it is possible to reduce the concentration of amine(s) in the thickener overflow 101 to a sub-ppm level.

Within context of this specification, electrocoagulation (EC) refers to a process, wherein a liquid, typically water, is treated electrochemically, namely by passing by electrically charged electrodes, in order to remove impurities. Multiple reactions may take place simultaneously as water to be treated is arranged to pass through an electrocoagulation cell. In its simplest form, an EC reactor may be made up of an electrolytic cell comprising one anode and one cathode. Oxidation of ions or neutral molecules takes place at the anode. Reduction of the ions or neutral molecules takes place at the cathode. Loss of electrons is called oxidation, while electron gain is called reduction. The electrolytic cell is an electrochemical cell that drives a redox reaction through the application of electrical energy. First, a metal ion may be driven into the water. On the surface of the cathode, water may be hydrolysed into hydrogen gas and hydroxide ions (OH⁻). Meanwhile, electrons flow freely to destabilize surface charges on suspended solids. As the reaction continues, flocs may be formed that entrain suspended solids and other contaminants. Finally, the flocs may be removed.

In electrocoagulation, a coagulant may be generated in situ by electrolytic oxidation of an appropriate anode material. Consumable metal plates, such as iron or aluminium, may be used as sacrificial electrodes to produce ions in the water to treated. The released ions may remove undesirable contaminants either by chemical reaction and/or precipitation, or by causing colloidal materials to coalesce. Additionally or alternatively, ionization, electrolysis, hydrolysis and/or free-radical formation may take place, thus altering the physical and chemical properties of the treated matter.

EC systems are typically constructed of at least one set of electrodes (usually in form of metal plates), through which water to be treated flows between the spaces of the electrodes. Typically, direct current is used in EC systems.

According to an embodiment, the electrocoagulation unit 220 comprises consumable metal plates, such as iron (Fe) or aluminium (Al) as the electrodes. The electrodes are arranged to produce ions into the cleaning flotation underflow. The produced ions may enable precipitation of amine(s) of the cleaning flotation underflow. The hydroxide ions produced at the cathode may raise the pH of the treated matter, i.e. the cleaning flotation underflow, and thus may further enable precipitation of the amine(s).

According to another embodiment, the electrocoagulation unit 220 comprises non-consumable metal plates, such as titanium (Ti) or stainless steel as the electrodes. Some of the amine(s) may get oxidized at the anode, while some may get reduced at the cathode. These reactions may have the effect of decreasing the solubility of the compounds, thus enabling their precipitation. The reactions may have the effect of altering chemistry of the amines. The hydroxide ions produced at the cathode may raise the pH of the treated matter, i.e. the cleaning flotation underflow, and thus may further enable precipitation of the amine(s).

According to an embodiment, prior to subjecting the thickener overflow 101 to electrocoagulation, temperature of the thickener overflow is from 0 to 50° C. Preferably, the temperature of the thickener overflow is from 0 to 35° C. The lower temperature of the thickener overflow decreases the solubility of the amine(s), and thus enables their separation by the electrocoagulation.

According to an embodiment, prior to supplying the thickener overflow 101 to the electrocoagulation unit 120, a solid matter content of the thickener overflow is determined. Overly high solid matter content of the substance to treated in the electrocoagulation unit is unwanted, as the excess solid matter may cause a short-circuit, and thus cause halting of the process.

In a case the solid matter content of the thickener overflow is determined to be overly high, i.e. over a pre-determined threshold value, for electrocoagulation, the thickener overflow is pre-treated in at least one pre-treatment unit, as illustrated in FIGS. 2-4. The aim of the pre-treatment of the thickener overflow is to remove the excess solids. By the pre-treatment, at least some amine(s) may also become removed. The pre-treatment may be performed for example by flotation and/or filtering. The pre-treatment unit may be a cleaning flotation unit and/or a sand filter unit.

According to an embodiment and as illustrated in FIG. 2, in a case the solid matter content of the thickener overflow 201 is determined to be overly high for electrocoagulation as such, the thickener overflow 201 is supplied to the cleaning flotation unit 202 for pre-treatment. In the cleaning flotation unit 202 the thickener overflow 201 is subjected to cleaning flotation in order to separate a cleaning flotation overflow 203 and in order to form a pre-treated thickener overflow as a cleaning flotation underflow 204. The cleaning flotation comprises gas bubbles, at least 90% of the gas bubbles having a diameter of from 0.2 to 250 μm. The cleaning flotation overflow 203 may comprise amine(s) and other undesired matter. The pre-treated thickener overflow, i.e. the cleaning flotation underflow 204, is then supplied to the electrocoagulation unit 220 and subjected to electrocoagulation, as described above. The thickener underflow 214, the cleaning flotation overflow 203 and the electrocoagulation overflow 222 may be removed as tailings 250.

According to an embodiment, the cleaning flotation is a dissolved air flotation (DAF). DAF is a flotation process which is used in various applications in water or effluent clarification. Solid particles are separated from liquid by using small flotation gas bubbles, which may be called microbubbles. The microbubbles are generated by dissolving air or other flotation gas into the liquid under pressure. The bubbles are formed in a pressure drop when dispersion is released. The particles of solid form attach to the bubbles and rise to the surface. A formed, floating sludge may be removed from the liquid surface with sludge rollers as DAF overflow. Chemicals may sometimes be needed to aid flocculation and increase solids removal efficiency. Typically, colloids removal is possible with efficient coagulation. However, in the method described here, no coagulant(s), flocculant(s), adsorbent(s) or additional flotation chemical(s) are used.

According to an embodiment and as illustrated in FIG. 3, in a case the solid matter content of the thickener overflow 301 is determined to be overly high for electrocoagulation as such, the thickener overflow 301 is supplied to the sand filter unit 330 for pre-treatment. In the sand filter unit 330 the thickener overflow 301 is filtered by allowing it to flow through a sand filter in order to produce a filtered thickener overflow 331. The sand filter may be a sand bed. The sand filter comprises sand, i.e. large silica (SiO₂) particles. The large silica particles are capable of collecting at least some of the amine(s) of the thickener overflow 301. Thus, a filtered thickener overflow 331 as the pre-treated thickener overflow is produced. The filtered thickener overflow 331 is supplied into an electrocoagulation unit 320 as described above. The filtered thickener overflow 331 is subjected to electrocoagulation in the electrocoagulation unit 320 in order to further separate at least some of the amine(s) as an electrocoagulation overflow 322 and to form a residual process water as an electrocoagulation underflow 321. The thickener underflow 314 and the electrocoagulation overflow 322 may be removed as tailings 350.

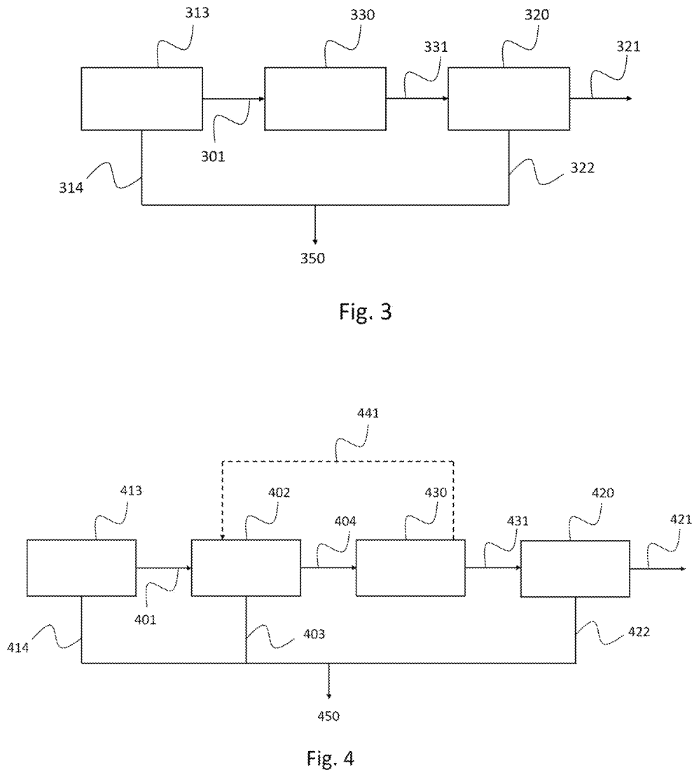

According to an embodiment and as illustrated by FIG. 4, in a case the solid matter content of the thickener overflow 401 is determined to be overly high for electrocoagulation as such, the thickener overflow 401 is first supplied to the cleaning flotation unit 402 for pre-treatment and subsequently to the sand filter unit 430 for further pre-treatment. In the cleaning flotation unit 402 the thickener overflow 401 is subjected to cleaning flotation in order to separate a cleaning flotation overflow 403 and to form a cleaning flotation underflow 404. The cleaning flotation comprises gas bubbles, at least 90% of the gas bubbles having a diameter of from 0.2 to 250 μm. The cleaning flotation underflow 404 is then supplied to the sand filter unit 430. In the sand filter unit 430 the cleaning flotation underflow 404 is filtered by allowing it to flow through a sand filter in order to produce a filtered thickener overflow 431. The sand filter may be a sand bed. The sand filter comprises sand, i.e. large silica (SiO₂) particles. The large silica particles are capable of collecting at least some of the amine(s) of the cleaning flotation underflow 404. Thus, a filtered thickener overflow 431 as the pre-treated thickener overflow is produced.

The sand filter may collect at least some of the amine(s) of the cleaning flotation underflow 404. Eventually this may lead to the sand filter being saturated by the collected amine(s). The sand filter may be cleaned, i.e. the collected amine(s) may be removed by subjecting the filter to a washing liquid. As illustrated by the dashed arrow in FIG. 4, the washing liquid 441 comprising the removed amine(s) may be led into the cleaning flotation unit 402 for cleaning flotation.

The filtered thickener overflow 431 is supplied into an electrocoagulation unit 420 as described above. The filtered thickener overflow 431 is subjected to electrocoagulation in the electrocoagulation unit 420 in order to further separate at least some of the amine(s) as an electrocoagulation overflow 422 and to form a residual process water as an electrocoagulation underflow 421. The thickener underflow 414, the cleaning flotation overflow 403 and the electrocoagulation overflow 422 may be removed as tailings 450.

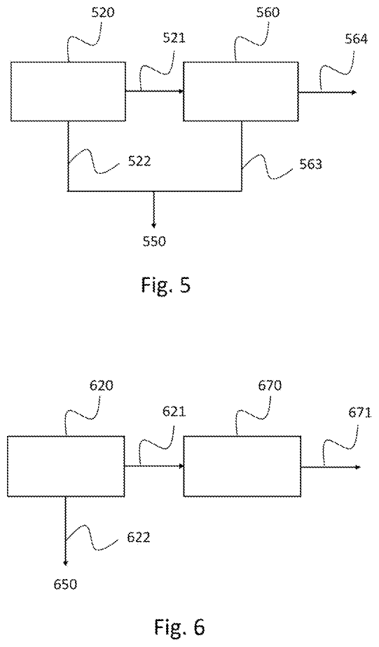

In a case further purification is preferred, the electrocoagulation underflow may be supplied to a (secondary) cleaning flotation unit 560 or to a (secondary) sand filter unit 670, as illustrated in FIGS. 5 and 6.

Thus, according to an embodiment and as illustrated in FIG. 5, the electrocoagulation underflow 521 is supplied to a (secondary) cleaning flotation unit 560 and subjected to cleaning flotation. Again, the cleaning flotation comprises gas bubbles, at least 90% of the gas bubbles having a diameter of from 0.2 to 250 μm. A (secondary) cleaning flotation overflow 563 is separated and a (secondary) cleaning flotation underflow 564 is formed. The definition “secondary” herein refers to a situation wherein prior to electrocoagulation the thickener overflow has already been subjected to a pre-treatment in a cleaning flotation unit, as illustrated by FIGS. 2 and 4. The electrocoagulation overflow 522 and the (secondary) cleaning flotation overflow 563 may be removed as tailings 550.

According to another embodiment and as illustrated in FIG. 6, the electrocoagulation underflow 621 is supplied to a (secondary) sand filter unit 670 and the electrocoagulation underflow 621 is filtered by allowing it to flow through a sand filter in the (secondary) sand filter unit 670 in order to produce a filtered electrocoagulation underflow 671. Again, the definition “secondary” herein refers to a situation wherein prior to electrocoagulation the thickener overflow has already been subjected to a pre-treatment in a sand filter unit, as illustrated by FIGS. 3 and 4. The electrocoagulation overflow 622 may be removed as tailings 650.

Again, as the sand filter may collect at least some of the amine(s) of the electrocoagulation underflow 621, the sand filter may get saturated by the collected amine(s). The sand filter may be cleaned, i.e. the collected amine(s) may be removed by subjecting the filter to a washing liquid. The washing liquid comprising the removed amine(s) may again be led into a cleaning flotation unit for cleaning flotation.

According to an embodiment, the electrocoagulation underflow 121, 221, 321, 421, 521, 621 and/or the (secondary) cleaning flotation underflow 564 and/or the filtered electrocoagulation underflow 671 is led via a tailings area into the environment. The tailings area may comprise for example an intermediate tank for stabilizing the electrocoagulation underflow 121, 221, 321, 421, 521, 621 and/or the (secondary) cleaning flotation underflow 564 and/or the filtered electrocoagulation underflow 671. Alternatively, the electrocoagulation underflow 121, 221, 321, 421, 521, 621 and/or the (secondary) cleaning flotation underflow 564 and/or the filtered electrocoagulation underflow 671 may be recirculated back into the process for use as process water.

The thickener overflow 101, 201, 301, 401 may comprise amine(s) adsorbed onto silicate(s). Thus, by the method described herein, it is possible to remove at least some of the silicate(s) comprised by the thickener overflow 101, 201, 301, 401.

As mentioned above, in closed-loop systems, wherein water is to be recirculated back into the process, silicates of the recirculated water may use up flotation chemicals and disrupt floating of silicates from the freshly introduced slurry infeed. Silicates may end up in the recovered ore, thus deteriorating both yield and quality of the recovered ore. Thus, the method described herein has the effect that the treated process water, i.e. the liquid obtained from the cleaning flotation unit and/or the sand filter unit and/or the electrocoagulation unit, is insofar pure in terms of amine and/or silicate content that it is possible to reuse the treated process water without negatively influencing the outcome of the process. Further, it is possible to lead the treated process water into the environment without causing harm to the environment.

1. A method for removing amine(s) from a thickener overflow of a mineral processing plant, wherein the thickener overflow comprises process water and amine(s);
the method comprising:
supplying the thickener overflow to an electrocoagulation unit and subjecting the thickener overflow to electrocoagulation in order to separate at least some of the amine(s) as an electrocoagulation overflow and in order to form a residual process water as an electrocoagulation underflow, and
removing the electrocoagulation overflow;
wherein the method is free of all of the following: a coagulant, a flocculant, an adsorbent and an additional flotation chemical.

2. The method according to claim 1, wherein the thickener overflow originates from a flotation arrangement comprising a mineral flotation circuit arranged to treat ore particles suspended in a slurry by flotation for separation of the slurry into an underflow of a mineral flotation circuit and an overflow of a mineral flotation circuit; and
wherein the overflow of the mineral flotation circuit is dewatered in the thickener in order to produce the thickener overflow and a thickener underflow.

3. The method according to claim 2, wherein the mineral flotation circuit is arranged to recover Fe.

4. The method according to claim 1,
wherein the method further comprises
prior to supplying the thickener overflow to the electrocoagulation unit, determining a solid matter content of the thickener overflow, and
if the solid matter content of the thickener overflow is determined to be over a pre-determined threshold value for electrocoagulation, pre-treating the thickener overflow in at least one pre-treatment unit; wherein the pre-treatment unit is a cleaning flotation unit and/or a sand filter unit and the thickener overflow to be treated in the electrocoagulation unit being a pre-treated thickener overflow.

5. The method according to claim 4, wherein the method comprises
supplying the thickener overflow to the cleaning flotation unit for pre-treatment and subjecting the thickener overflow to cleaning flotation in order to separate a cleaning flotation overflow and in order to form the pre-treated thickener overflow as a cleaning flotation underflow; wherein the cleaning flotation comprises gas bubbles, at least 90% of the gas bubbles having a diameter of from 0.2 to 250 μm.

6. The method according to claim 4, wherein the method comprises
supplying the thickener overflow or the cleaning flotation underflow to the sand filter unit for pre-treatment and filtering the thickener overflow or the cleaning flotation overflow by allowing it to flow through a sand filter in the sand filter unit in order to produce a filtered thickener overflow or a filtered cleaning flotation underflow as the pre-treated thickener overflow.

7. The method according to claim 1, wherein the method further comprises
supplying the electrocoagulation underflow to a (secondary) cleaning flotation unit and subjecting the electrocoagulation underflow to cleaning flotation in order to separate a (secondary) cleaning flotation overflow and in order to form a (secondary) cleaning flotation underflow.

8. The method according to claim 1, wherein the method further comprises
supplying the electrocoagulation underflow to a (secondary) sand filter unit and filtering the electrocoagulation underflow by allowing it to flow through a sand filter in the (secondary) sand filter unit in order to produce a filtered electrocoagulation underflow.

9. The method according to claim 4, wherein the cleaning flotation is a dissolved air flotation.

10. The method according to claim 1, wherein the method further comprises
leading the electrocoagulation underflow and/or the (secondary) cleaning flotation underflow and/or the filtered electrocoagulation underflow via a tailings area into the environment.

11. The method according to claim 1, wherein the method further comprises
recirculating the electrocoagulation underflow and/or the (secondary) cleaning flotation underflow and/or the filtered electrocoagulation underflow back into the process for use as process water.

12. The method according to claim 1, wherein the electrocoagulation unit comprises Fe electrodes.

13. The method according to claim 1, wherein the electrocoagulation unit comprises Ti electrodes.

14. The method according to claim 1, wherein prior to subjecting the thickener overflow to electrocoagulation, temperature of the overflow is from 0 to 50° C.

15. The method according to claim 1, wherein the thickener overflow comprises amine(s) adsorbed onto silicate(s), and the method comprises removing at least some of the silicate(s) from the thickener overflow.

16. An arrangement for removing amine(s) from a thickener overflow of a mineral processing plant, wherein the thickener overflow comprises process water and amine(s) the arrangement comprising;
a thickener arranged to dewater an overflow of a mineral flotation circuit in order to produce a thickener overflow and a thickener underflow,
an electrocoagulation unit arranged separate at least some of the amine(s) from the thickener overflow as an electrocoagulation overflow and to form a residual process water as an electrocoagulation underflow.

17. The arrangement according to claim 16, further comprising
a mineral flotation circuit arranged to treat ore particles suspended in a slurry by flotation and arranged to separate the slurry into an underflow of a mineral flotation circuit and the overflow of a mineral flotation circuit.

18. The arrangement according to claim 16, further comprising
a device arranged to determine a solid matter content of the thickener overflow, and
at least one pre-treatment unit arranged to pre-treat the thickener overflow; wherein the pre-treatment unit is a cleaning flotation unit and/or a sand filter unit.

19. The arrangement according to claim 16, further comprising
a (secondary) cleaning flotation unit arranged to separate a (secondary) cleaning flotation overflow and to form a (secondary) cleaning flotation underflow.

20. The arrangement according to claim 16, further comprising
a (secondary) sand filter unit arranged to produce a filtered electrocoagulation underflow.

21. The arrangement according to claim 18, wherein the (secondary) cleaning flotation unit is a dissolved air flotation unit.
